(19) United States
(12) Patent Application Publication
(10) Pub. No.: US 2024/0154330 A1
(43) Pub. Date: May 9, 2024

(54) COMPACT RELIABLE ELECTRICAL CONNECTOR

(71) Applicant: Amphenol East Asia Electronic Technology (Shenzhen) Co., Ltd., Shenzhen (CN)

(72) Inventors: Kangqin Li, Shenzhen (CN); Zhimin Qin, Shenzhen (CN)

(73) Assignee: Amphenol East Asia Electronic Technology (Shenzhen) Co., Ltd., Shenzhen (CN)

(21) Appl. No.: 18/500,294

(22) Filed: Nov. 2, 2023

(30) Foreign Application Priority Data
Nov. 8, 2022 (CN) 202222975557.X

(51) Int. Cl. H01R 12/71; H01R 13/502; H01R 13/631

(52) U.S. Cl. CPC H01R 12/716; H01R 13/502; H01R 13/631

(57) ABSTRACT

A compact, reliable electrical connector. The connector may include terminals held by a housing, which may be formed as a subassembly. The subassembly may be disposed in a shell. The terminals may have mating ends accessible through an opening of the shell and mounting ends opposite the mating ends. The shell may include a wall having a mounting face configured to face a circuit board that the connector should be mounted to, and a member integrated with the wall having the mounting face. The member may position the connector on the circuit board. The member may also electrically couple the shell to ground structures in the circuit board. Such a configuration reduces the risk of misaligning the connector with the circuit board due to, for example, relative movements between a positioning member of the connector and the other components of the connector.

### RELATED APPLICATION

This application claims priority to and the benefit of Chinese Patent Application Serial No. 202222975557.X, filed on Nov. 8, 2022, entitled “ELECTRICAL CONNECTOR,” the contents of which are incorporated herein by reference in their entirety.

### FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as several printed circuit boards (PCB) which may be joined together with electrical connectors than to manufacture the system as a single assembly. For example, connectors are often used to connect a video/audio source to a display device such as a computer monitor. The connectors are often made according to industry standards (e.g., the Video Electronics Standards Association (VESA)).

### BRIEF SUMMARY

Aspects of the present application relate to compact reliable electrical connectors.

Some embodiments relate to an electrical connector. The electrical connector may include a plurality of terminals; a housing holding the plurality of terminals; and a shell disposed outside the housing. The shell may include a wall comprising a mounting face; and a member integrated with the wall and extending from the mounting face in a direction substantially perpendicular to the mounting face.

Optionally, the member may have a hollow core.

Optionally, the member may comprise a same material as the wall of the shell.

Optionally, the member may comprise a different material than the wall of the shell.

Optionally, the member may comprise at least one of copper, a copper alloy, a zinc alloy, an aluminum alloy, or stainless steel.

Optionally, the member is disposed in a central portion of the mounting face; and the shell may comprise a plurality of tails disposed around a boundary of the mounting face.

Optionally, the wall may comprise a pair of beams configured to engage a mating connector; the member may comprise a proximal end connected to the wall; and the proximal end may be disposed between the pair of beams.

Optionally, the wall of the shell may comprise an opening; and the member extends from an edge of the opening and may comprise a hollow core.

Optionally, the member may comprise a plurality of branching portions disposed about a central axis of the member.

Optionally, the member may comprise a base portion, the base portion connected to the wall at a proximal end of the member, a guiding portion tapering towards a distal end of the member opposite the proximal end of the member, and an intermediate portion connecting the base portion and the guiding portion; and the intermediate portion may have a diameter less than a diameter of the base portion at the proximal end of the member.

Optionally, the wall comprising the mounting face may be a lower wall of the shell; the shell may comprise an upper wall substantially parallel to the lower wall, a pair of side walls disposed between the upper wall and the lower wall and spaced from each other; and each of the pair of side walls may comprise a plurality of tails extending therefrom in the direction substantially perpendicular to the mounting face.

Optionally, the shell may comprise a rear wall connected with the pair of side walls and the upper wall; and the rear wall may comprise a pair of connecting portions each having a hole configured to receive a protrusion extending from the pair of side walls, respectively.

Optionally, the housing may comprise at least one recess; and at least one of the upper wall and the lower wall of the shell may comprise at least one beam that engages the at least one recess of the housing.

Some embodiments relate to an electronic system. The electronic system may include a circuit board comprising a surface; and an electrical connector mounted on the circuit board. The electrical connector may include a shell comprising a wall facing the surface of the circuit board and a member extending from the wall into the circuit board; and a subassembly at least partially disposed in the shell, the subassembly comprising a plurality of terminals and a housing holding the plurality of terminals.

Optionally, the member of the shell may electrically couple the shell to ground structures in the circuit board.

Optionally, the shell may comprise a pair of side walls extending substantially perpendicular to the wall and a plurality of tails extending from the pair of side walls into the circuit board.

Optionally, the wall may comprise a pair of beams configured to engage a mating connector; the member may comprise a proximal end connected to the wall; and the proximal end may be disposed between the pair of beams.

Some embodiments relate to a method of manufacturing an electrical connector. The method may include stamping a preform of a shell from a single sheet; bending the preform of the shell to form a wall comprising a mounting face, and a pair of side walls extending substantially perpendicular to the wall; disposing a subassembly in the shell such that the wall and the pair of side walls at least partially bound the subassembly; and forming a member extending from the wall of the shell in a direction perpendicular to the wall.

Optionally, forming the member may comprise bending portions of the preform of the shell.

Optionally, the member may be formed separately from stamping the preform of the shell; and forming the member may comprise welding an end of the member to the wall of the shell.

Some embodiments relate to an electrical connector. The electrical connector may include a shell and a subassembly. The subassembly may comprise a plurality of terminals and a housing holding the plurality of terminals. The subassembly may be inside the shell.

The shell may include: an upper wall and a lower wall substantially parallel to the upper wall; a left side wall and a right side wall substantially parallel to and spaced apart from the left side wall, each of the left side wall and the right side wall being provided between the upper wall and the lower wall and connected to both of the upper wall and the lower wall, and each of the left side wall and the right side wall being provided thereon with a plurality of tails that extend continuously from the left side wall or the right side wall in a direction perpendicular to the lower wall and away from the upper wall; a rear wall connected with the left side wall, the right side wall, and the upper wall. The subassembly may be inserted in a cavity enclosed by the upper wall, the lower wall, the left side wall, the right side wall and the rear wall. A positioning member may be provided at an outer surface of the lower wall of the shell, the positioning member may extend in a direction perpendicular to the lower wall outwardly from the outer side of the shell, and the positioning member and the lower wall are formed as an integrated piece.

Optionally, the positioning member may be formed as a cylindrical body with a hollow core.

Optionally, an opening may be provided on the lower wall of the shell, the end of the positioning member that is connected to the lower wall may be concentric with the opening, and an inner wall of the end of the positioning member may be at least partially connected to a circumferential inner edge portion of the opening.

Optionally, the positioning member may comprise a plurality of branching portions (such as petal-like portions), the plurality of branching portions may be arranged about a central axis of the positioning member in a manner of being spaced apart from each other, and the end of each of the plurality of branching portions that is connected with the lower wall may be at least partially connected to a circumferential inner edge portion of the opening.

Optionally, the positioning member may be provided at a substantially central portion on the outer surface of the lower wall of the shell.

Optionally, the positioning member may be a hollow copper cylinder, a hollow copper alloy cylinder, a hollow zinc alloy cylinder, a hollow aluminum alloy cylinder, or a hollow stainless steel cylinder.

Optionally, the positioning member may have a base portion at a proximal end of the positioning member, a guiding portion at a distal end of the positioning member, and an intermediate portion connecting the base portion with the guiding portion. The base portion may include a first end having a larger diameter at a proximal end of the base portion, and a second end having a smaller diameter opposite to the first end. The base portion may taper from the first end toward the second end. The base portion may be connected to the outer surface of the lower wall of the shell at the first end and may be connected with the intermediate portion at the second end. The intermediate portion may be configured to have a diameter that is the same as the diameter of the second end of the base portion. The guiding portion may be connected to a distal end of the intermediate portion opposite to the base portion and may be shaped to be tapered from the intermediate portion toward the distal end of the positioning member.

Optionally, the positioning member may be shaped to have a circular, oval, triangular, square, or irregularly-shaped cross-section.

Optionally, the positioning member may be a hollow projection part formed from the lower wall of the shell by stamping and bending.

Optionally, the positioning member may be a hollow cylindrical part formed from the lower wall of the shell by stamping and drawing.

Optionally, the upper wall, the lower wall, the left side wall, the right side wall, the rear wall, the plurality of tails, and the positioning member are made as a unitary component by processing a single sheet.

Optionally, the housing of the subassembly may include at least one recess. At least one of the upper wall and the lower wall of the shell may include at least one member that may engage the at least one recess.

Optionally, the rear wall may include a left side connecting portion substantially parallel to the left side wall, and a right side connecting portion substantially parallel to the right side wall. Each of the left side connecting portion and the right side connecting portion may include at least one hole. The left side wall may include at least one snapping portion for producing a snap-fit with the at least one hole of the left side connecting portion. The right side wall may include at least one snapping portion for producing a snap-fit with the at least one hole of the right side connecting portion.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a top, front perspective view of an electrical connector, showing being mounted onto a circuit board, according to some embodiments.

FIG. 2 is a top view of the electrical connector of FIG. 1.

FIG. 3 is a bottom view of the electrical connector of FIG. 1.

FIG. 4 is a front view of the electrical connector of FIG. 1.

FIG. 5 is a side view of the electrical connector of FIG. 1.

FIG. 6 is a partially exploded view of the electrical connector of FIG. 1.

FIG. 7 is a bottom, side perspective view of the electrical connector of FIG. 1.

FIG. 8 is a bottom, rear perspective view of the electrical connector of FIG. 1.

FIG. 9 is a front view of the electrical connector of FIG. 8.

FIG. 10 is a bottom view of the electrical connector of FIG. 8.

FIG. 11 is a rear, side perspective view of an electrical connector, according to some embodiments.

### DETAILED DESCRIPTION

The Inventors have recognized and appreciated connector design techniques that enable connectors to be accurately and reliably aligned with circuit boards to which the connectors are mounted. The Inventors have recognized and appreciated that a conventional connector usually includes a separately molded component in order to provide a positioning post for aligning the connector with a circuit board. As the connector including the separately molded component is assembled, the location of the positioning post may deviate from the desired location. The separately molded component may move relative to other components of the connector or even fall off the connector, making the connector unreliable. The separately molded component also adds to manufacturing costs.

The Inventors have recognized and appreciated that a connector can have a positioning member integrated with a shell of the connector, which can provide accurate and reliable alignment between the connector and the circuit board to which the connector is mounted. Such a configuration can reduce the risk of misaligning the connector with the circuit board due to, for example, relative movements between a positioning member of the connector and the other components of the connector even under the force generated by a mating connector, and therefore enable reliable alignment. Such a configuration can remove the need for a separately molded component and therefore reduce manufacturing costs. The positioning member can be conductive and optionally may be configured to electrically couple the shell to ground structures in the circuit board, which can improve the integrity of the signals transmitted by the connector.

In some embodiments, a connector may include a subassembly having terminals held by a housing. The subassembly may be disposed in a shell. The subassembly may be directly attached to the shell or may be coupled to the shell through an outer housing or other intermediate component. The terminals may have mating ends accessible through an opening of the shell and mounting ends opposite the mating ends. The shell may include a wall having a mounting face configured to face a circuit board that the connector should be mounted to, and a pair of side wall extending substantially perpendicular to the wall and spaced from each other. The housing of the subassembly and the shell may have matching features (e.g., beams and recesses) that engage each other so as to prevent relevant movements between the shell and the subassembly.

A positioning member can be integrated with the wall having the mounting face so as to align the connector with the circuit board when the positioning member is inserted into a desired location of the circuit board. The positioning member may be formed of the same or a different material than the shell. The positioning member may be disposed in a central portion of the mounting face. For example, the wall having the mounting face may have a pair of beams configured to engage a mating connector. The positioning member may have a proximal end connected to the wall at a location between the pair of beams. With such a configuration, the positioning member may provide sufficient mechanical strength to support the subassembly, and/or provide electrical connections to the ground structures of the circuit board with relatively similar lengths of paths for various portions of the shell.

The positioning member may be integrally formed with the wall of the shell or attached to the wall of the shell. In some embodiments, a preform of the shell may include portions that can form the positioning member by, for example, bending and/or rolling the portions. In some embodiments, the positioning member may be separately formed and attached to the wall of the shell by, for example, laser welding. Further, the positioning member may have a hollow core. Such configurations enable easy manufacturing and reduce manufacturing costs.

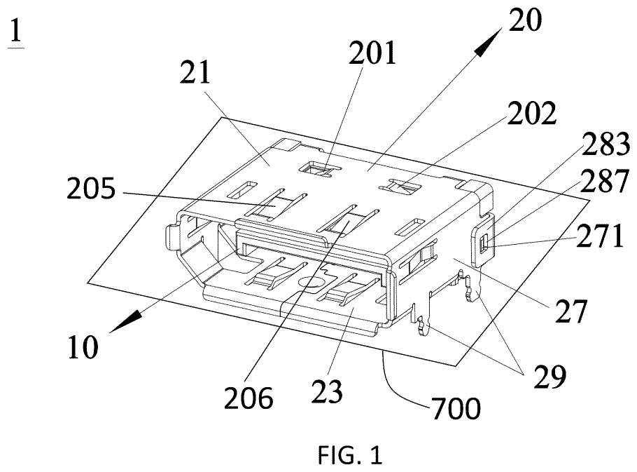

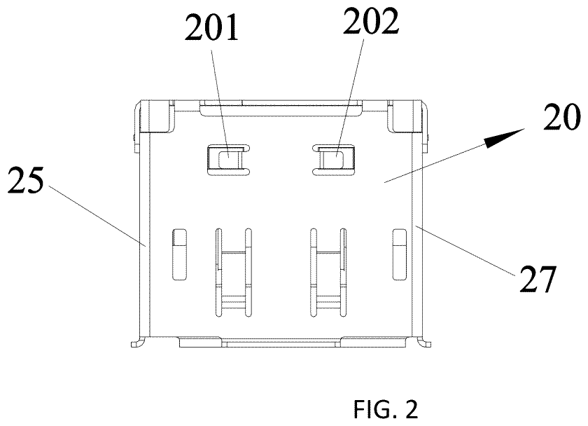

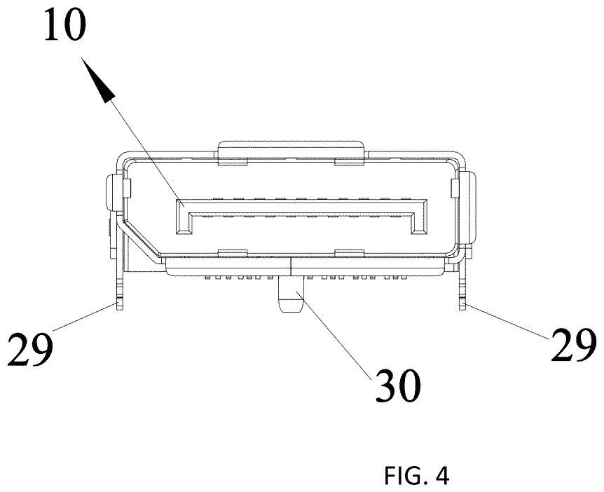

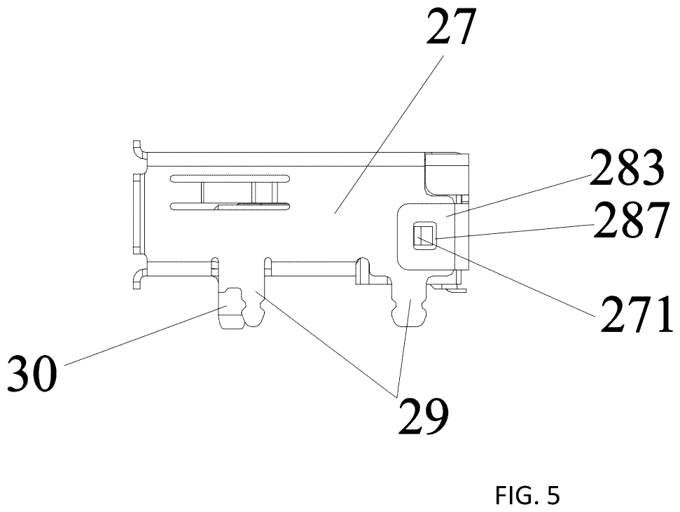

Referring to FIGS. 1 to 7, an electronic system may include an electrical connector 1 mounted onto a circuit board 700. The electrical connector 1 may include a subassembly 10 and a shell 20. The subassembly 10 may include a plurality of terminals 500 and a housing 400 holding the plurality of terminals 500 (e.g., a base portion 402 surrounding the outer side of the plurality of terminals 500, and a tongue portion 404 extending beyond the base portion 402 and holding mating ends of the plurality of terminals). The subassembly 10 is at least partially disposed in the shell 20. Each terminal 500 may include a mating end 502 accessible through an opening of the shell 200 and a mounting end 504 opposite the mating end 502.

The shell 20 may include an upper wall 21 and a lower wall 23, which may be substantially parallel to each other; a left side wall 25 and a right side wall 27, which may be substantially parallel to each other. The lower wall 23 may include a mounting face 702 configured to face a surface of the circuit board 700 when the electrical connector 1 is mounted to the circuit board 700. Each of the left side wall 25 and the right side wall 27 may be disposed between the upper wall 21 and the lower wall 23 and connected to both of the upper wall 21 and the lower wall 23. Each of the left side wall 25 and the right side wall 27 may include a plurality of tails 29 extending continuously therefrom in a direction perpendicular to the lower wall 23 and away from the upper wall 21. The shell 20 may include a rear wall 28 connected to the left side wall 25, the right side wall 27, and the upper wall 21.

The subassembly 10 may be disposed in a cavity 200, which may be at least partially bounded by the upper wall 21, the lower wall 23, the left side wall 25, the right side wall 27, and the rear wall 28. A positioning member 30 may extend from an outer surface of the lower wall 23 of the shell 20. The positioning member 30 may extend in a direction perpendicular to the lower wall 23 outwardly from the outer side of the shell 20. The positioning member 30 and the lower wall 23 may be formed as an integrated piece so as to reduce the risk of misaligning the positioning member 30 with and/or disengaging the positioning member 30 from the lower wall 23.

In the description of the present application, it should be understood that orientation or positional relations indicated by terms such as “upper”, “lower”, “front”, “rear”, “left”, “right”, “vertical”, “horizontal”, “top”, “bottom”, “inside” and “outside” are based on the orientation or positional relations as shown in the figures, only for facilitating description of the present application and simplifying the description, rather than indicating or implying that the referred devices or elements must be in a particular orientation or constructed or operated in the particular orientation, and therefore they should not be construed as limiting the present application.

Such a configuration eliminates the need to form and assemble a separate component by, for example, injection molding in order to provide a positioning structure. Such a configuration therefore enables a simple manufacturing process, reduced manufacturing cost, and improved reliability.

In some examples, the shell 20 may be a unitary component. For example, a preform of the shell 20 may be formed by processing a sheet (e.g., metal sheet). The preform may comprise portions which are respectively corresponding to an upper wall 21, a lower wall 23, a left side wall 25, a right side wall 27, a rear wall 28, a plurality of tails 29, and a positioning member 30 of the shell 20. Optionally, a preform of the shell 20 in the form of a unitary component may be made by processing a sheet (e.g., metal sheet). Optionally, the shell 20 may be formed by stamping and bending the preform. In some examples, the shell 20 may be substantially in a box-shape with an open end. In some examples, the shell 20 may have a generally cylindrical shape with an open portion. In some r examples, the shell 20 may have a front open portion configured to receive a mating connector.

The subassembly 10 may be accommodated in the shell 20 and the housing 400 of the subassembly 10 may abut the rear wall 28 of the shell 20. At least one recess (e.g., recesses 101, 102) may be provided on the housing 400 of the subassembly 10 (e.g., the upper portion and/or the lower portion of the housing 400). At least one of the upper wall 21 and the lower wall 23 of the shell 20 may include a beam (e.g., beams 201, 202) that engages the corresponding recess. When the subassembly 10 is disposed in the shell 20, the recess in the housing of the subassembly 10 may engage (e.g., snap-fitted) the beam in the upper wall 21 and/or the lower wall 23 of the shell 20, to allow the subassembly 10 to be secured in place in the shell 20.

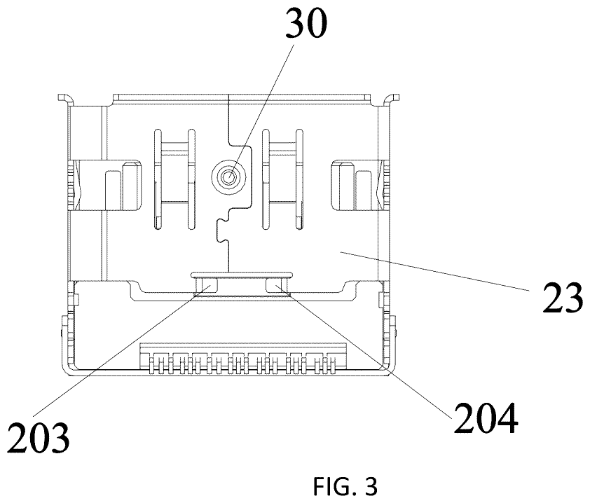

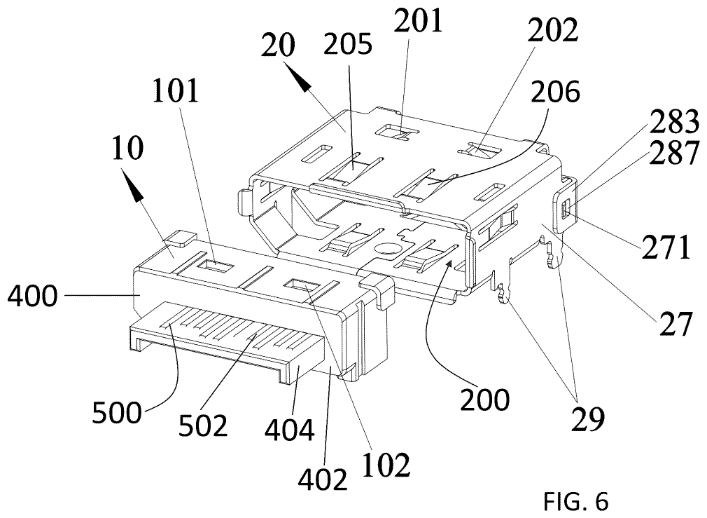

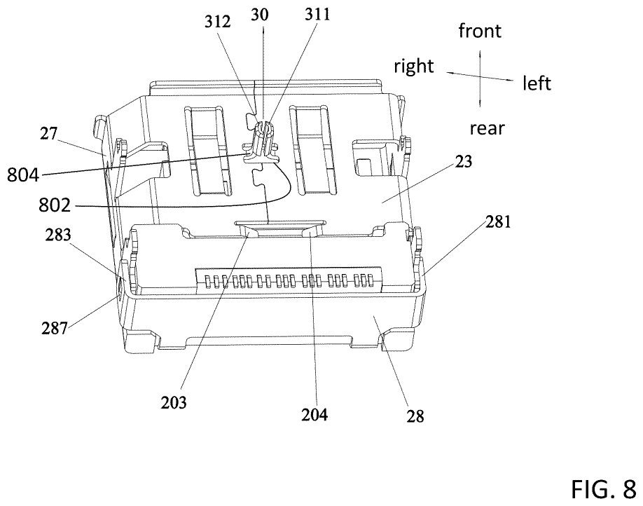

In the example illustrated in FIG. 6, the upper portion of the housing 400 of the subassembly 10 may include recesses 101, 102. The upper wall 21 of the shell 20 may include beams 201, 202 that are configured to engage the respective recesses 101, 102. As shown in FIGS. 3 and 8, the lower wall 23 of the shell 20 may include beams 203, 204 that are configured to engage recesses (not shown) provided on a lower portion of the housing 400. The upper wall 21 and/or the lower wall 23 of the shell 20 may include beams 205, 206 that are configured to engage a mating connector, which may indicate when the connectors are fully mated and prevent risks of over insertion. Such a configuration secures the housing 400 of the subassembly 10 to the shell 20 and reduces the risk of relative movements between the housing 400 of the subassembly 10 and the shell 20 even under the force generated by a mating connector.

In some examples, as the shell 20 may include four tails 29 (e.g., four connecting leg portions). One pair of the tails 29 may extend beyond the lower wall 23 continuously from the left side wall 25 in a direction perpendicular to the lower wall 23 and away from the upper wall 21. Another pair of tails 29 may extend continuously beyond the lower wall 23 from the right side wall 27 in a direction perpendicular to the lower wall 23 and away from the upper wall 21. In some examples, the pair of tails 29 extending from the left side wall 25 or the right side wall 27 may be configured to have different sizes and configurations and spaced apart from each other. The plurality of tails 29 may be configured to connect with the circuit board 700 by, for example, soldering. The tails 29 may secure the electrical connector 1 to the circuit board 700 and/or provide connections between the shell 20 and ground structures in the circuit board 700.

In some examples, a plurality of beams (e.g., beams 205, 206) may be provided on the upper wall 21, the lower wall 23, the left side wall 25, and/or the right side wall 27 of the shell 20. When a mating connector (for example, a plug) is inserted into the electrical connector (for example, a receptacle), an elasticity force exerted by the beams may be applied on the mating electrical connector in a direction towards an inner side of the shell 20. Such a configuration can secure the mating electrical connector in place and reduce the risk of unintended disengagement of the mated connectors.

In some embodiments, the rear wall 28 may include a left side connecting portion substantially parallel to the left side wall 25 and a right side connecting portion substantially parallel to the right side wall 27. Each of the left side connecting portion and the right side connecting portion may include at least one hole, the left side wall may include at least one snapping portion for producing a snap-fit with at least one hole of the left side connecting portion, and the right side wall may include at least one snapping portion for producing a snap-fit with the at least one hole of the right side connecting portion. The rear wall 28 may be connected with the left side wall 25 and the right side wall 27 by snap-fitting. In an example, the left side connecting portion 281 and the right side connecting portion 283 of the rear wall 28 (as shown in FIG. 8) may be provided to have a substantially symmetrical structure. As shown in the illustrated example of FIG. 1, the right side connecting portion 283 of the rear wall 28 may include a hole 287, the right side wall 27 may include a snapping portion 271 which may be configured to form a snap-fit connection with the hole 287, so as to allow the right side connecting portion 283 of the rear wall 28 to be securely connected with the right side wall 27. For example, the snapping portion 271 may be configured as a projection having a trapezoidal cross-section.

In some examples, each of the left side connecting portion and the right side connecting portion may include at least one snapping portion. The left side wall may include at least one hole for producing a snap-fit with at least one snapping portion of the left side connecting portion. The right side wall may include at least one hole for producing a snap-fit with at least one snapping portion of the right side connecting portion. With this configuration, it is also possible to achieve detachable connections between the left side connecting portion of the rear wall and the left side wall, and between the right side connecting portion of the rear wall and the right side wall.

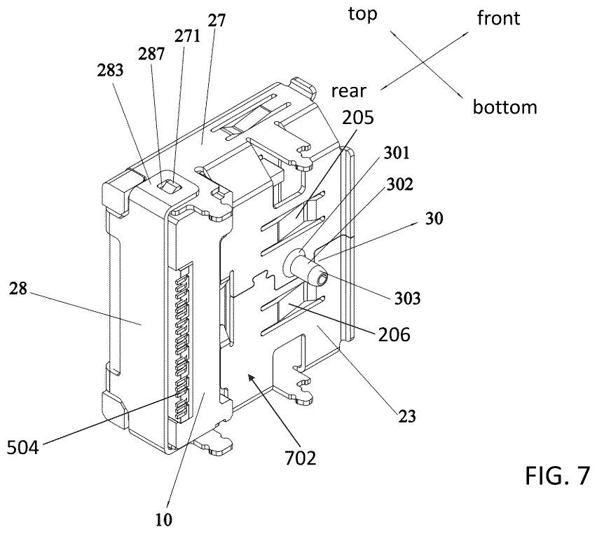

As shown in FIG. 7, the positioning member 30 may have a proximal end connected to the lower wall 23 of the shell 20 and disposed between the beams 205, 206 of the lower wall 23 of the shell. In some embodiments, the positioning member 30 may be formed as a cylindrical body with a hollow core (as shown in FIG. 7). The positioning member 30 is configured to engage a corresponding positioning hole on a circuit board (PCB) that the electrical connector is to be mounted. Such a configuration enables aligning the shell 20 of the electrical connector with the circuit board accurately and reliably. Optionally, the positioning member 30 may have a height in a range of 1 mm to 6 mm. The positioning member 30 may have an outer diameter in a range of 3 mm to 6 mm. The positioning member 30 may have an inner diameter in a range of 2 mm to 3 mm. The number of the positioning members may be one or more (e.g., two).

With the hollow positioning member, saving in material can be obtained and manufacturing cost is reduced. In addition, when the positioning member is assembled with the corresponding positioning hole in the circuit board, since the hollow positioning member has good ductility, manufacturing errors generated by providing the positioning member on the shell of the electrical connector and mounting the subassembly of the electrical connector into the shell can be effectively compensated. Furthermore, stress concentration is avoided. Therefore, while the manufacturing process and the producing procedure for the electrical connector are simplified, and an accurate alignment and positioning of the positioning member on the shell of the electrical connector in relation to the corresponding positioning hole in the circuit board can be ensured.

Optionally, the positioning member 30 may be substantially provided at a central part on the lower wall 23 of the shell 20. In further examples, three positioning members may be arranged/distributed in a form of an isosceles triangular in the lower wall 23 of the shell 20. It should be understood that one or more of the positioning members may be integrated with the lower wall 23 at any suitable location on the outer surface of the lower wall 23 of the shell 20. The size, number and arrangement of the positioning members 30 may be adjusted upon actual assembling requirements and/or respective industry standards.

In some embodiments, the positioning member 30 may be formed of the same material as the material of the shell 20. Optionally, the shell 20 may be a metal shell made of a metallic material. The material of the shell 20 and the positioning member 30 may be selected from, for example, but not limited to, one of the following materials: copper, a copper alloy, a zinc alloy, an aluminum alloy, and stainless steel. In some embodiments, the positioning member 30 may be formed as an electrically conductive positioning member.

Since the positioning member 30 is electrically conductive, when the electrical connector 1 is mounted onto the circuit board, the positioning member 30 of the electrical connector 1 may engage one or more ground layers of the circuit board (e.g., PCB), and provide connections between the electrical connector and the ground layers.

In some embodiments, the lower wall 23 of the shell 20 may (e.g., at a central portion of the lower wall) be formed with an opening. The end of the positioning member 30 that is connected to the lower wall 23 may be concentric with the opening. The positioning member 30 may extend in a direction perpendicular to the lower wall 23 away from the upper wall 21 toward the outer side of the shell 20.

The positioning member 30 may be formed as a cylindrical body with a hollow core. An inner wall of an end of the positioning member 30 that is connected to the lower wall 23 may be at least partially connected to a circumferential inner edge portion of the opening. In some examples, as shown in FIG. 7, the positioning member 30 may have a base portion 301 positioned at a proximal end thereof, a guiding portion 303 positioned at a distal end of the positioning member, and an intermediate portion 302 connecting the base portion 301 with the guiding portion 303. The base portion 301 may include a first end having a larger diameter at a proximal end of the base portion, and a second end having a smaller diameter opposite to the first end. The base portion 301 may taper from the first end toward the second end. The base portion 301 may be connected to the outer surface of the lower wall 23 of the shell 20 at the first end and may be connected to the intermediate portion at the second end. The intermediate portion 302 may be configured to have a diameter that is the same as the diameter of the second end of the base portion 301. The guiding portion 303 may be connected to a distal end of the intermediate portion 302 opposite to the base portion 301 and may be shaped to be tapered from the intermediate portion 302 toward a distal end of the positioning member 30. The guiding portion 303 of the positioning member 30 may be configured to guide the positioning member 30 of the shell 20 to align with the corresponding positioning hole of the circuit board so as to improve alignment efficiency.

The proximal end of the positioning member 30 may refer to the end of the positioning member 30 that is connected with the lower wall. The distal end of the positioning member 30 may refer to the end opposite to the proximal end of the positioning member 30.

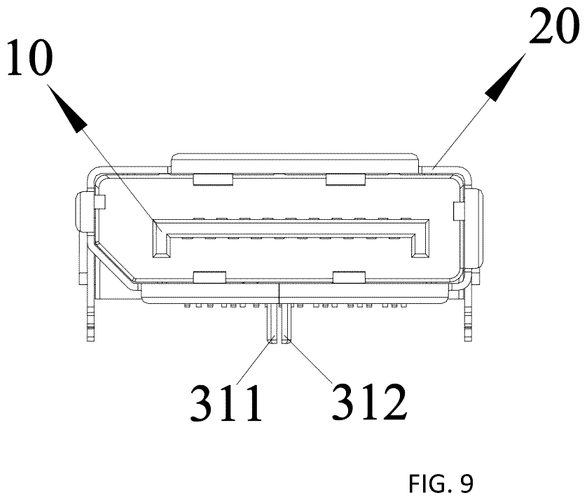

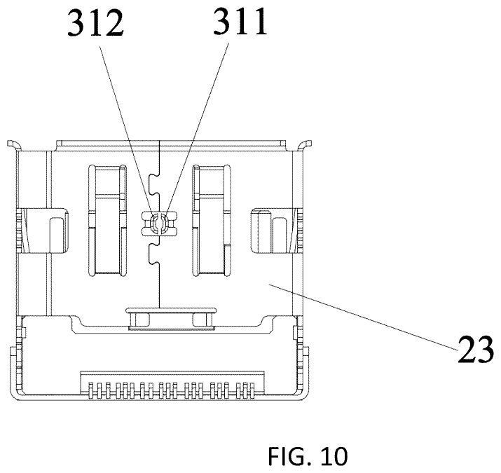

In some embodiments, the lower wall 23 may include an opening 802. The end of the positioning member 30 that is connected with the lower wall 23 may be concentric with the opening 802. The positioning member 30 may extend in a direction perpendicular to the lower wall 23 and away from the upper wall 21 toward the outer side of the shell 20. As shown in FIGS. 8 to 10, the positioning member 30 may comprise a first branching portion 311 and a second branching portion 312. The two branching portions may be arranged about a central axis of the positioning member 30 and spaced apart from each other. Optionally, each of the first branching portion 311 and the second branching portion 312 may include a curved portion 804 at the end adjacent to the opening 802. The curved portion 804 may be configured to be at least partially connected to the circumferential inner edge of the opening 802. Optionally, the positioning member 30 shown in FIG. 8 may be formed from the lower wall 23 of the shell 20 by stamping and bending.

In some embodiments, the positioning member 30 may comprise three or more branching portions. Optionally, the three or more branching portions may be arranged about a central axis of the positioning member 30 in an equally spaced manner. Optionally, predetermined gaps may be formed between adjacent branching portions. An end of each of the plurality of branching portions is at least partially connected to the circumferential inner edge of the opening.

The central axis of the positioning member 30 may refer to an axis perpendicular to the lower wall 23 passing through a central point of the positioning member 30.

In some examples, the positioning member 30 may be a hollow projection part extending from the lower wall of the shell 20. The positioning member 30 and lower wall 23 of the shell 20 may be formed by stamping and bending a same sheet (e.g., metal sheet). In some examples, the positioning member may be a hollow cylindrical part extending from the lower wall of the shell 20. The positioning member 30 and the lower wall 23 of the shell 20 may be formed by stamping and drawing a same sheet (e.g., metal sheet).

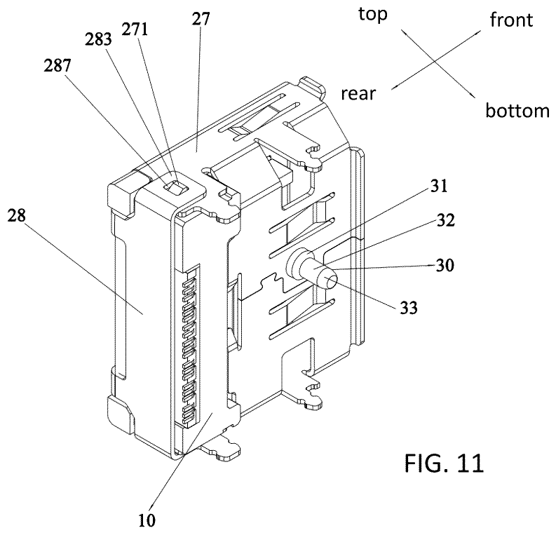

In some embodiments, as shown in FIG. 11, the positioning member 30 may be formed to have a post-like shape and have a tapered guiding portion 33, a step portion 31, and an intermediate portion 32 disposed between the guiding portion 33 and the step portion 31. The step portion 31 may be connected with the outer surface of the lower wall 23 of the shell 20. The step portion 31 may have a diameter larger than the diameter of the intermediate portion 32. Optionally, the step portion 31 may be connected to the outer surface of the lower wall 23 of the shell 20 by welding (e.g., laser welding) so that the positioning member 30 and the lower wall 23 of the shell 20 are formed as an integrated piece. Optionally, the positioning member 30 may be formed of a different material from the material of the shell 20.

In some embodiments, the positioning member may be formed as a hollow, triangular prism body. Optionally, the positioning member may be formed as a hollow, polyhedral prism body. In addition, each edge of the polyhedral prism body may be rounded to facilitate engagement of the positioning member 30 of the shell 20 with the positioning hole of the circuit board. Optionally, the positioning member may have, but is not limited to, a circular, oval, triangular, rhombus, or irregularly-shaped cross-section.

With the electrical connector according to an exemplary embodiment of the present application, the positioning member of the present application is provided on an outer surface of the lower wall of the shell of the electrical connector, and the positioning member and the lower wall are formed as an integrated piece, compared with the related technical solution in which the positioning member is formed on the internal assembly of the electrical connector, in particular on the main housing disposed on the outer side of the terminal assembly. Thus, in the technical solution of the present application, it is not required to form a positioning member by injection molding while molding the main housing on the outer side of the terminal assembly, and there is no need of assembling step of mounting an injection molded component formed with a positioning member to the main housing, which greatly simplifies the molding process for the internal assembly of the electrical connector, optimizes the production process, and reduces production costs. In addition, the positioning member and the shell are formed as an integrated piece, the positioning member can be firmly formed on the shell without a risk of deviating or falling off, and the precise alignment and positioning of the terminal assembly of the electrical connector in relation to the circuit board can be ensured, so as to achieve a stable, reliable signal transmission.

With the electrical connector according to the exemplary embodiments of the present application, since the positioning member formed as a cylindrical body with a hollow core has good mechanical properties, such as a strong impact resistance, a good toughness, and a fairly good resistance to bending, the manufacturing errors generated by providing the positioning member on the shell of the electrical connector and mounting the internal assembly of the electrical connector into the shell can be effectively compensated, thereby simplifying the manufacturing process and the producing process for the electrical connector, and also ensuring an accurate alignment and positioning of the positioning member formed on the shell of the electrical connector in relation to the corresponding positioning hole provided in the circuit board. In addition, saving in material can be obtained by providing a hollow positioning member, and the manufacturing cost is accordingly reduced.

With the electrical connector according to the exemplary embodiment of the present application, in a process that the plurality of branching portions of the positioning member are engaged with the corresponding positioning hole provided in the circuit board, the plurality of branching portions of the positioning member are simultaneously in contact with the positioning hole at a plurality of positions, and one or more branching portions of the positioning member may be tilted in a radial direction due to the force exerted by the positioning hole of the circuit board, thereby acting as buffers (such as damping member) to effectively compensate for the manufacturing errors generated by providing the positioning member on the shell of the electrical connector and mounting the internal assembly of the electrical connector into the shell. Thus, it is possible to ensure the precise alignment and proper positioning of the positioning member formed on the shell of the electrical connector in relation to the corresponding positioning hole provided in the circuit board.

With the electrical connection according to the exemplary embodiment of the present application, the positioning member can be made of metal materials, so that the positioning member has good toughness, high strength and good ductility. Furthermore, the positioning member of the electrical connection according to the present application is easy to be welded, cold pressure processing and thermal pressure processing can be easily performed on the positioning member, and the positioning member also has good electrical conductivity and thermal conductivity. In addition, since the positioning member is electrically conductive, the positioning member formed on the shell of the electrical connector may be engaged with a ground layer of the circuit board (e.g., PCB), and thus an additional connection between the electrical connector and the ground layer is provided.

With the electrical connector according to the exemplary embodiment of the present application, the guiding portion having a tapered-shape may facilitate an easier and faster engagement of the positioning member with the positioning hole of the circuit board, thereby improving assembling efficiency.

Aspects of the present application relate to methods for manufacturing electrical connectors. In some embodiments, the method of manufacturing an electrical connector may include processing a sheet (e.g., metal sheet) to form a preform of the shell, wherein the preform may include an upper wall, a lower wall, a left side wall, a right side wall, and a rear wall. In some embodiments, the method may include forming a positioning member at the lower wall of the preform. The method may include forming the shell by stamping and bending. In some embodiments, the method may include forming a preform of the positioning member separate from forming the preform of the shell. The preform of the positioning member or the positioning member may be attached to the shell by, for example, laser welding.

A cavity for accommodating the subassembly of the electrical connector may be at least partially bounded by the upper wall, the lower wall, the left side wall, the right side wall, and the rear wall.

The method of manufacturing the electrical connector may include providing the plurality of terminals and the housing of the subassembly 10. For example, the housing of the subassembly may be formed by injection molding.

Optionally, the method of manufacturing the electrical connector may include cutting, shearing, stamping, etc. of a sheet (e.g., metal sheet) to form a preform of the shell. The preform may include an upper wall, a lower wall, a left side wall, a right side wall, and a rear wall. The method may include forming a positioning member at the lower wall of the preform. The method may include providing a subassembly 10, which may include a plurality of terminals and a housing holding the plurality of terminals. The method may include inserting the subassembly 10 into the preform of the shell, a partially formed version of the shell, or the shell. The method may include forming the shell by stamping and bending. A cavity for accommodating the subassembly 10 of the electrical connector 1 may be at least partially bounded by the upper wall, the lower wall, the left side wall, the right side wall, and the rear wall.

In some examples, when the finished subassembly 10 is inserted into the preform of the shell 20, the recesses in the housing of the subassembly 10 may form snap-fit connections with the members provided in the upper wall 21 and/or the lower wall 23 of the shell 20, so as to secure the subassembly 10 in place in the shell 20. The rear wall 28 of the preform of the shell may be bent along a predetermined bending line so that the rear wall 28 is formed with a left side connecting portion 281 substantially parallel to the left side wall 25 and a right side connecting portion 283 substantially parallel to the right side wall 27. A hole formed in the left side connecting portion 281 may form a snap-fit connection with the snapping portion formed in the left side wall 25. A hole formed in the right side connecting portion 283 may form a snap-fit connection with the snapping portion formed in the right side wall 27. A cavity for accommodating the subassembly 10 of the electrical connector may therefore be at least partially bounded by the upper wall 21, the lower wall 23, the left side wall 25, the right side wall 27, and the rear wall 28.

In some embodiments, forming a positioning member at the lower wall of the preform may comprise forming a positioning member at the lower wall of the preform by a process of stamping and bending or by a process of stamping and drawing, or welding a preformed positioning member onto the lower wall of the preform.

The stamping process may use stamping equipment (presses) and tools (dies). For example, pressure may be exerted on a sheet (e.g., metal or a non-metal material) to allow a separation or plastic deformation thereof, thereby obtaining a product with a certain shape, size and meeting certain performance requirements. “Stamping and bending” may include a stamping process in which the material to be processed is bent along a bending line to obtain a certain angle and shape. “Stamping and drawing” may include a stamping process in which a hollow component is made by a flat plate material by using a stamping die, or the shape and size of the hollow component is further changed.

The positioning member is formed by the stamping and bending process or the stamping and drawing process. Various metallic and non-metallic materials can be used. The method may provide high processing accuracy, high productivity, and high material utilization. The manufacturing cost may be reduced. the stamping bending process or the stamping and drawing process may facilitate mass manufacturing, thereby facilitating to implement a high degree of mechanization and automation. The integration of the shell 20 and the positioning member 30 may provide improved mechanical properties.

In some embodiments, welding a preformed positioning member onto the lower wall of the preform of the shell may include forming an opening at the lower wall and welding the preformed positioning member at the opening of the lower wall.

In some embodiments, welding a preformed positioning member onto the lower wall of the preform of the shell may include manufacturing a preformed positioning member by stamping and drawing a second sheet different from a first sheet used to manufacture the shell, and welding the preformed positioning member onto the lower wall of the preform by laser beam welding.

For example, a preform of the shell 20 may be made of the first sheet by stamping and bending. The positioning member 30 may be made of the second sheet by stamping and drawing. The finished positioning member 30 formed by stamping may be welded onto the outer surface of the lower wall 23 of the preform of the shell. In some embodiments, the positioning member 30 and the shell 20 may be made of different materials.

During the laser welding, energy may be released extremely quickly, thereby increasing the manufacturing productivity and/or effectively reducing the amount of oxidation used by the welding material. The laser welding may have a high energy density and a relatively concentrated heat amount, resulting in a very small heat-affected zone. After being focused, a laser beam can obtain a very small spot and can be precisely positioned. Laser welding may enable the automated mass production of components of the electrical connectors.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

For example, although DisplayPort receptacle electrical connectors are illustrated, techniques described herein can be used in any suitable connector, such as an HDMI connector, a USB Type-C connector, or a DVI connector, etc., such that the connector can be accurately and reliably mounted to a circuit board.

As another example, although inventive concepts have been shown and described with reference to a connector having a right angle configuration, it should be appreciated that the aspects of the present disclosure are not limited in this regard, as any one of the creative features, whether alone or in combination with one or more other inventive concepts, may be used in other types of electrical connectors, such as coplanar connectors, stacking connectors, I/O connectors, chip sockets, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation d1, d2 for a value could be as high as 50%. For example, if an operable range extends from 2 to 200, “approximately 80” may encompass values between 40 and 120 and the range may be as large as between 1 and 300. When only exact values are intended, the term “exactly” is used, e.g., “between exactly 2 and exactly 200.” The term “essentially” is used to indicate that values are the same or at a target value or condition to within ±3%.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector comprising:
a plurality of terminals;
a housing holding the plurality of terminals; and
a shell disposed outside the housing, the shell comprising
a wall comprising a mounting face; and
a member integrated with the wall and extending from the mounting face in a direction substantially perpendicular to the mounting face.

2. The electrical connector of claim 1, wherein:
the member has a hollow core.

3. The electrical connector of claim 1, wherein:
the member comprises a same material as the wall of the shell.

4. The electrical connector of claim 1, wherein:
the member comprises a different material than the wall of the shell.

5. The electrical connector of claim 1, wherein:
the member comprises at least one of copper, a copper alloy, a zinc alloy, an aluminum alloy, or stainless steel.

6. The electrical connector of claim 1, wherein:
the member is disposed in a central portion of the mounting face; and
the shell comprises a plurality of tails disposed around a boundary of the mounting face.

7. The electronic system of claim 1, wherein:
the wall comprises a pair of beams configured to engage a mating connector;
the member comprises a proximal end connected to the wall; and
the proximal end is disposed between the pair of beams.

8. The electrical connector of claim 1, wherein:
the wall of the shell comprises an opening; and
the member extends from an edge of the opening and comprises a hollow core.

9. The electrical connector of claim 8, wherein:
the member comprises a plurality of branching portions disposed about a central axis of the member.

10. The electrical connector of claim 1, wherein:
the member comprises a base portion, the base portion connected to the wall at a proximal end of the member, a guiding portion tapering towards a distal end of the member opposite the proximal end of the member, and an intermediate portion connecting the base portion and the guiding portion; and
the intermediate portion has a diameter less than a diameter of the base portion at the proximal end of the member.

11. The electrical connector of claim 1, wherein:
the wall comprising the mounting face is a lower wall of the shell;
the shell comprises an upper wall substantially parallel to the lower wall, a pair of side walls disposed between the upper wall and the lower wall and spaced from each other; and
each of the pair of side walls comprises a plurality of tails extending therefrom in the direction substantially perpendicular to the mounting face.

12. The electrical connector of claim 11, wherein:
the shell comprises a rear wall connected with the pair of side walls and the upper wall; and
the rear wall comprises a pair of connecting portions each having a hole configured to receive a protrusion extending from the pair of side walls, respectively.

13. The electrical connector of claim 1, wherein:
the housing comprises at least one recess; and
at least one of the upper wall and the lower wall of the shell comprises at least one beam that engages the at least one recess of the housing.

14. An electronic system comprising:
a circuit board comprising a surface; and
an electrical connector mounted on the circuit board, the electrical connector comprising:
a shell comprising a wall facing the surface of the circuit board and a member extending from the wall into the circuit board; and
a subassembly at least partially disposed in the shell, the subassembly comprising a plurality of terminals and a housing holding the plurality of terminals.

15. The electronic system of claim 14, wherein:
the member of the shell electrically couples the shell to ground structures in the circuit board.

16. The electronic system of claim 14, wherein:
the shell comprises a pair of side walls extending substantially perpendicular to the wall and a plurality of tails extending from the pair of side walls into the circuit board.

17. The electronic system of claim 14, wherein:
the wall comprises a pair of beams configured to engage a mating connector;
the member comprises a proximal end connected to the wall; and
the proximal end is disposed between the pair of beams.

18. A method of manufacturing an electrical connector comprising:
stamping a preform of a shell from a single sheet;
bending the preform of the shell to form a wall comprising a mounting face, and a pair of side walls extending substantially perpendicular to the wall;
disposing a subassembly in the shell such that the wall and the pair of side walls at least partially bound the subassembly; and
forming a member extending from the wall of the shell in a direction perpendicular to the wall.

19. The method of claim 18, wherein forming the member comprises:
bending portions of the preform of the shell.

20. The method of claim 18, wherein:
the member is formed separately from stamping the preform of the shell; and
forming the member comprises welding an end of the member to the wall of the shell.
